(19) United States
(12) Patent Application Publication
(10) Pub. No.: US 2014/0058751 A1
(43) Pub. Date: Feb. 27, 2014

(54) DIAGNOSTIC MEDICAL INFORMATION BROKER SYSTEM AND METHOD

(71) Applicant: ORTHOSCAN, INC., Scottsdale, AZ (US)

(72) Inventors: Christopher B. Eaves, Scottsdale, AZ (US); Adam Menzies, Tempe, AZ (US)

(73) Assignee: ORTHOSCAN, INC., Scottsdale, AZ (US)

(21) Appl. No.: 13/906,282

(22) Filed: May 30, 2013

Related U.S. Application Data
(63) Continuation of application No. 13/223,126, filed on Aug. 31, 2011, now abandoned.
(60) Provisional application No. 61/378,731, filed on Aug. 31, 2010.

(51) Int. Cl. G06F 19/00

(52) U.S. Cl. CPC G06F 19/321
USPC 705/3

(57) ABSTRACT

A medical information broker system and method is disclosed, that advantageously allows for brokering medical information directly between a diagnostic imaging modality and a EMR system. The system can include, for example, a communications module configured to receive at least one file containing patient data from a diagnostic imaging modality in a first format, and send the at least one file to a destination modality in a second format; a diagnostic information converter module in electronic communication with the communications module and configured to convert the at least one file from the first format to the second format; and a work list engine in electronic communication with the communications module and configured to create a task list accessible via a user.

### CROSS-REFERENCE TO RELATED APPLICATIONS

This application claims priority under 35 U.S.C §120 as a continuation of U.S. patent application Ser. No. 13/223,126 filed on Aug. 31, 2011, which in turn claims priority under 35 U.S.C. §119(e) to U.S. Provisional Patent Application No. 61/378,731, filed Aug. 31, 2010. The disclosure of each of the priority applications are incorporated in its entirety herein by reference.

### BACKGROUND OF THE INVENTION

1. Field of the Invention

The invention relates in some aspects to an integrated hardware-software system for accessing and distributing patient data between a medical diagnostic modality and patient medical record. More specifically, in some embodiments, disclosed is an integrated hardware-software system for brokering medical images directly between a medical imaging modality and an electronic medical record.

2. Description of the Related Art

The medical industry, in keeping with the developments and capabilities made available with digital technologies, has begun to adopt electronic medical records, electronic health records, and/or the like (collectively “EMR”). The EMR is intended to be a complete historical record of a patient's medical record. It may include patient information such as biographical information including patient name, date of birth, sex, medical record and other patient identification number, insurance information, verbal and/or written physician/medical professional notes, diagnoses, treatments, prescribed drugs or treatments, allergies, reactions, prior or scheduled operations or procedures, instructions, observations, analysis or interpretation of test results, medical images or the like, laboratory and/or test results including electrocardiogram results, or the like.

As with most technologies, adoption of the EMR has resulted in some problems. There are a variety of EMR vendors who provide EMR systems to hospitals and other medical facilities. “Hospital” or “medical facility” as used herein are interchangeable, and both terms comprise without limitation hospitals, private doctors' offices, medical imaging facilities, clinics, emergency and/or urgent care centers, mobile care centers, medical kiosk stations, computer stations of medical professionals, both at homes and at offices, and other medical facilities. In certain embodiments, the term “medical facility” also comprises retail outlets (both online and physical retail stores), manufacturers, and the like. In certain embodiments, the term “medical facility” also comprises but is not limited to third party individuals, consultants, contractors, and/or outsourcing facilities.

Each of these EMR systems may have its own proprietary or unique user and/or communication interfaces. These various EMR systems may be rendered in a variety of computer languages, such as, C+, C++, Visual Basic, XML, Java, or the like. EMR systems may also be configured to receive specific file types or formats of patient diagnostic data.

Given the variety of standards, protocols, formats and the lack of standardization across EMR formats, there is a need for a system which will interface, such as directly with a diagnostic modality and transfer the diagnostic information from the modality to a patient's EMR.

### SUMMARY OF THE INVENTION

In accordance with some embodiments, a diagnostic medical information broker system may comprise, among other elements, a communication module, a file conversion module, and a tracking module. The system may be in electronic communication with a medical diagnostic modality and/or a patient EMR. As such, the diagnostic medical information broker system provides for, among other things, the relaying of diagnostic medical information and/or patient information between a medical diagnostic modality and an EMR system.

Also disclosed herein is a medical information broker system, that can comprise a communications module configured to receive at least one file containing patient data from a diagnostic imaging modality in a first format, and send the at least one file to a destination modality in a second format; a diagnostic information converter module in electronic communication with the communications module and configured to convert the at least one file from the first format to the second format; and a work list engine in electronic communication with the communications module and configured to create a task list accessible via a user.

Also disclosed herein is a method of brokering medical information directly between a diagnostic modality, such as a diagnostic imaging modality and a destination modality, such as an EMR system, comprising the steps of receiving at least one image file from a diagnostic imaging modality in a first format; converting the at least one image file from a first format to a second format; and transmitting the at least one image file in the second format to the EMR system.

### BRIEF DESCRIPTION OF THE DRAWINGS

The subject invention will hereinafter be described in conjunction with the appended drawing figures, wherein like numerals denote like elements, and wherein;

FIG. 1 is a block diagram depicting various interactions of a diagnostic medical information broker system.

FIG. 2 is a block diagram depicting various system components for a diagnostic medical information broker system.

FIG. 3 is a block diagram depicting various interactions and elements of a diagnostic medical information broker system.

FIG. 4 is another block diagram depicting various interactions and elements of a diagnostic medical information broker system.

FIG. 5 is another block diagram depicting various interactions and elements of a diagnostic medical information broker system.

FIGS. 6A-6B illustrate conventional steps that a physician can manually take to move images from a diagnostic modality to an electronic medical record system.

FIG. 6C illustrates an automated process in which a diagnostic medical broker system can move images from a diagnostic modality to an electronic medical record system without requiring intermediate steps requiring human interaction.

FIGS. 7A-7B illustrate conventional steps that a physician can manually take to move images from a diagnostic modality to an electronic medical record system.

FIG. 7C illustrates a process in which a diagnostic medical broker system can move images from a diagnostic modality to an electronic medical record system without requiring, or minimizing intermediate steps requiring human interaction.

### DETAILED DESCRIPTION

The detailed description of various embodiments herein makes reference to the accompanying drawing figures. While these embodiments are described in sufficient detail to enable those skilled in the art to practice the invention, it should be understood that other embodiments may be realized and that logical, electrical, programming, and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the individual operating components of the systems) may not be described in detail herein. Furthermore, the connecting lines shown in the various figures contained herein are intended to represent examples of functional relationships and/or physical couplings between the various elements. It should be noted that many alternative or additional functional relationships or physical connections may be present in a practical system.

As an initial matter, it should be understood that various embodiments of the present invention can be employed as a diagnostic medical information broker system, where medical information is collected at a medical diagnostic modality and transmitted to a patient EMR. While described in the context of medical information systems, it should be appreciated that the disclosed broker system may be applicable to any information system that requires the transfer of encrypted or decrypted data in a first format, conversion of that data to a second format by a broker system and storage of the converted data on another system. As such, the disclosed information broker system may be adaptable to, for example, financial information systems, or classified information systems in the defense and security industries.

A “user” may include any individual or entity that interacts with a system or participates in a process. A user may perform tasks such as requesting, retrieving, receiving, updating, analyzing, entering and/or modifying data. User may be, for example, be a healthcare provider, technician, doctor, nurse, medical assistant, service provider, client, manager, employee, and the like.

Transferring information as disclosed herein can include transferring, facilitating the transferring, causing the transferring, having something transferred, sending, transmitting, causing the transmitting, or the like.

The term “Picture Archiving and Communication System” (PACS) as used herein refer to systems and devices for the acquisition, archival and retrieval of digital images over a computer network, for diagnosis and review at workstations. In certain embodiments, PACS can be configured to interface or communicate directly with a Hospital Information System (HIS) and/or Radiology Information System (RIS) using an HL7 connection. In certain embodiments, a PACS can communicate with a RIS or HIS through a PACS Broker. A PACS broker is a device that allows the PACS to interface with an HIS or RIS. In certain embodiments, a PACS can comprise, without limitation, for example, a worklist broker, an image server, an archive manager; display workstation software, and other components. In certain embodiments, a PACS is connected to an image server.

In some embodiments, systems and components as described herein can take the form of a computing system that is in communication with one or more computing systems and/or one or more data sources via one or more networks. The computing system may be used to implement one or more of the systems and methods described herein. While various embodiments illustrating computing systems and components are described herein, it is recognized that the functionality provided for in the components and modules (which may also be referred to herein as engines) of computing system may be combined into fewer components and modules or further separated into additional components and modules. For example, a communications engine may include a first module in communication with a diagnostic imaging modality and a second module in communication with a destination modality. Modules can include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Any modules can be executed by one or more CPUs.

A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage. In addition, all the methods described herein may be executed as instructions on a CPU, and may result in the manipulation or transformation of data.

In some embodiments, hardware components of the system includes a CPU, which may include one, two, or more conventional microprocessors. The system further includes a memory, such as random access memory (“RAM”) for temporary storage of information and a read only memory (“ROM”) for permanent storage of information, and a mass storage device, such as a hard drive, flash drive, diskette, or optical media storage device. Typically, the modules of the system are connected using a standard based bus system. In different embodiments, the standard based bus system could be Peripheral Component Interconnect (“PCP”), Microchannel, Small Computer System Interface (“SCSI”), Industrial Standard Architecture (“ISA”) and Extended ISA (“EISA”) architectures, for example.

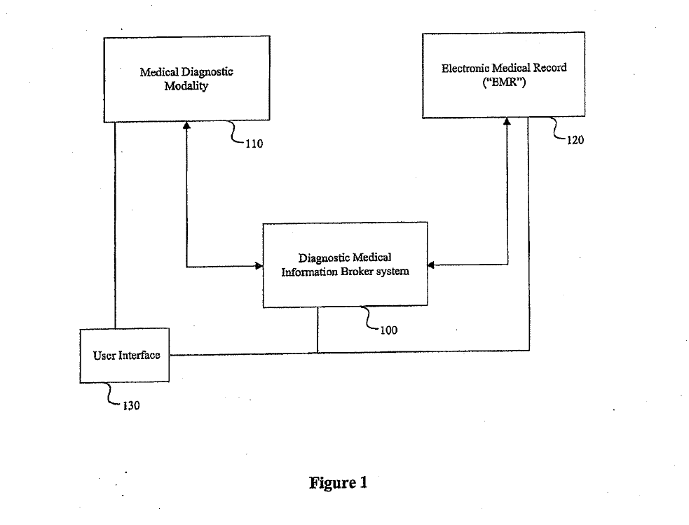

In accordance with various embodiments and with reference to FIG. 1, diagnostic medical information broker system 100 may be operatively coupled to a medical modality 110. While described primarily with regard to diagnostic information, it will be appreciated that treatment information including information from operative procedures, medication administration, and administration of therapeutic radiation also is within the scope of the invention. Medical diagnostic modality 110 may be any system configured to measure, evaluate, analyze, capture, and/or record diagnostic information from a patient. In accordance with various embodiments, medical diagnostic modality 110 may be any electronic medical diagnostic modality configured to communicate diagnostic information. Medical diagnostic modality 110 may be a medical imager, such as, for example, one adapted to perform one or more of radiographic imaging, magnetic resonance imaging, nuclear imaging, thermographic imaging, tomography, ultrasound imaging, and/or the like. In accordance with another embodiment, medical diagnostic modality 110 is an x-ray imager, such as, for example, a C-arm or mini C-arm x-ray imager. In some embodiments, the diagnostic modality 110 can have features as described, for example, in U.S. Pat. Pub. No. 2010/0239073 A1 to Eaves et al., U.S. Pat. No. 6,234,672 to Tomasetti et al., or U.S. Prov. Pat. App. No. 61/438,221, all of which are hereby incorporated by reference in their entireties.

In accordance with some embodiments, diagnostic medical information broker system 100 may be operatively coupled to a destination modality, such as, for example, an electronic medical record (“EMIR”) 120. EMR 120 may be any software or hardware-software system configured to store and provide access to electronic medical data. In accordance with various embodiments, EMR 120 may be at least one of an electronic medical record, an electronic health record, and the like. In some embodiments, the diagnostic medical information broker system 100 can be operatively coupled to a destination modality that can be an email or other messaging modality; SAMBA, Windows, or other file sharing modality; FTP or SFTP server modality; a VPN; a printer; and the like.

In accordance with some embodiments, the diagnostic medical information broker system 100 may comprise one, two, or more software modules, a logic engine, numerous databases and computer networks configured to provide a user with access to one, two, or more diagnostic modalities and/or an EMR. Diagnostic medical information broker system 100 may be configured such that patient data, or no patient data is recorded by the system. While the system may contemplate upgrades or reconfigurations of existing processing systems, changes to existing databases and business information system tools are not necessarily required. Diagnostic medical information broker system 100 may be implemented or integrated into existing healthcare information management systems, such as EMRs, without changes to the EMR system, and may interface with any medical diagnostic modality without changes to the communication system of the modality.

In accordance with certain embodiments and with continued reference to FIG. 1, diagnostic medical information system 100, medical diagnostic modality 110, and EMR 120 may be operatively coupled to user interface 130. User interface 130 may be any software or hardware-software system configured to provide a user with access and control to at least one of diagnostic medical information system 100, medical diagnostic modality 110, and EMR 120.

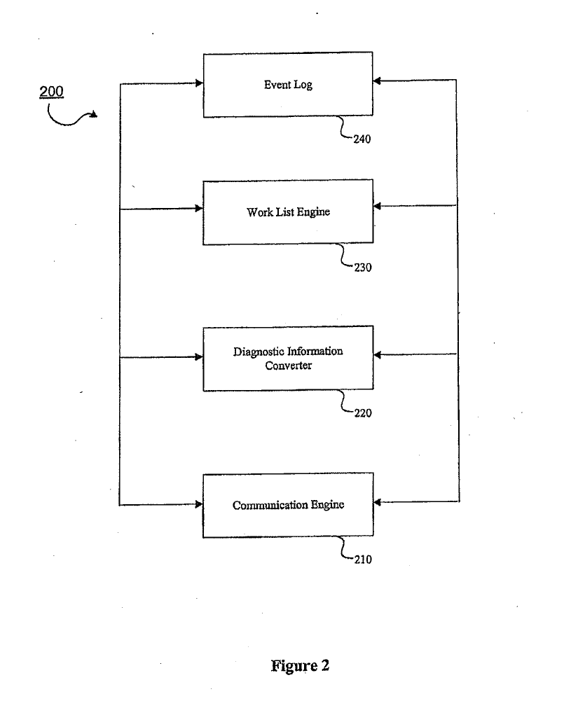

In accordance with some embodiments, a diagnostic medical information broker system 100 may be a software or hardware-software system. For example, with reference to FIG. 2, diagnostic medical information broker system 200 comprises a communication engine 210 configured to receive and transmit diagnostic medical information operatively coupled to: a diagnostic information converter 220 configured to render diagnostic medical information in a suitable format for storage in a patient EMR; a work list engine 230 configured to create a user selectable task list from orders captured at an EMR and selectable by a user at a medical diagnostic modality; and an event log 240 configured with a user selectable record of transactions and/or errors in data transmission and/or data conversion performed by diagnostic medical information broker system 200.

In accordance with some embodiments, communication engine 210 may be any software or hardware software-system configured to receive and/or transmit data. Communication engine 210 may be configured to transmit and receive data over a variety of network interfaces including wired and wireless networks or a combination thereof, such as via Ethernet, 802.11x, Bluetooth, FireWire, GSM, CDMA, LTE, and the like. Communication engine 210 may also be configured to transmit and/or receive data with file transfer protocols such as TCP/IP, as well as various encryption protocols, such as, for example, WEP, WPA, WPA2, and/or the like.

Furthermore, in some embodiments, a communication engine 210 may be configured as an active or passive module. When communication engine 210 is passive, it may be configured to be discoverable by various elements of a larger healthcare management system. In this way, communication engine 210 may be configured to receive a command or request from a medical diagnostic modality for a user selected patient, such that the communication engine may transmit the request to an EMR, receive the patient data for a specific patient from the EMR, and transfer the patient data from the EMR to the medical diagnostic modality. As such, communication engine 210 is only configured to receive and transmit data. In some embodiments, communication engine is not configured to collect, capture, or mine data from, either, an EMR or a medical diagnostic modality.

In accordance with some embodiments, communication engine 210 is configured to communicate encrypted data using HL7 messaging. The terms “Health Level 7” or “HL7” as used herein refer to an ANSI accredited standard developed to allow transfer of data between different systems in healthcare. This standard for transferring data operates at the top level of the open system integration model, or at the application layer. While many medical facilities use this standard, other standards exist. Accordingly, the foregoing terms are broad terms that also refer to other standards for managing data between different healthcare systems, and the systems and methods disclosed herein can be used with, applied to, and/or operate in an environment using HL7 or any other standard for managing data between healthcare systems. Communication engine 210 may employ HL7 messaging to transmit requests, notifications, commands and/or file attribute information between the medical diagnostic modality 110 and/or EMR 120 to mange diagnostic data transfers and conversions. For example, the diagnostic medical information broker system 200, including communication engine 210 and/or diagnostic image converter 220 may be configured to, among other things: (1) receive encrypted diagnostic patient information from medical diagnostic modality 110; (2) decrypt diagnostic patient information; (3) convert the diagnostic patient information to an EMR file format; (4) name the converted EMR file in a convention to associate the converted EMR file with a patient EMR; (5) notify the EMR 120 that there is a new EMR file for a specified EMR patient record; (6) encrypt the converted EMR image; (7) transfer the encrypted, converted EMR image to the EMR 120; and/or (8) receive a confirmation message from the EMR 120 that the transferred file was received. As such, each of the steps above may include HL7 messaging to notify medical diagnostic modality 110 and/or the EMR 120 of the action being taken by diagnostic medical information broker system 200.

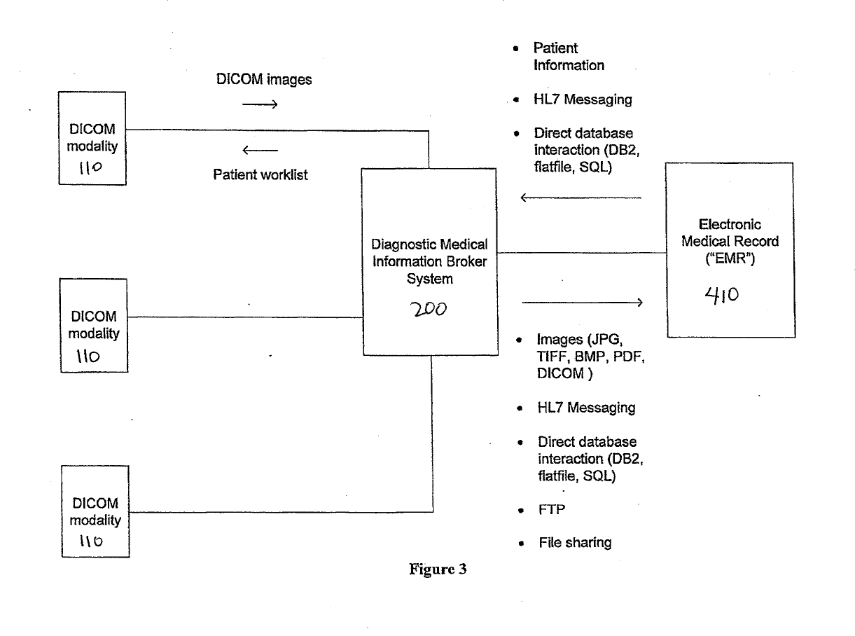

In accordance with some embodiments, diagnostic medical information converter 220 is in electronic communication with communication engine 210. In accordance with various embodiments, diagnostic information converter 220 may be any software or hardware-software system configured to render diagnostic medical information from a format provided by a medical diagnostic modality to a format receivable by an EMR. In accordance with one embodiment and with reference to FIG. 3, diagnostic information converter 220 may be configured to render a modality format DICOM image (Digital Imaging and Communications in Medicine, which is a common format and communications protocol for storing and/or sending medical images), to at least one EMR format: such as, for example, a JPEG file, a TIFF file, a RAW file, a PNG file, a GIF file, a BMP file, a PDF file, an EPS file, a DCM file, and/or the like in compressed or uncompressed, or in a lossy or lossless format. Each image can be saved individually, or stacked together by study. In accordance with some embodiments, diagnostic information convertor 220 may be configured to render a modality format DICOM video, to at least one EMR format: such as, for example, an AVI file, an MPEG file, a MOV file, an MP4 file, a DVD file, a Blu-Ray file, an FLV file, an WMV file, a SWF file, and/or the like. In addition to these common EMR formats, diagnostic information converter 220 can also be configured to convert to other image and video file formats now known or hereinafter devised. Video format conversion may be especially useful in certain procedures such as fluoroscopy including cardiac catheterization, neurovascular and peripheral vascular angiography, echocardiography, fetal or other ultrasonography, endoscopy, laparoscopy, sleep studies, and the like. The diagnostic information converter 220 can be configured to manipulate the DICOM image via one, two, or more if compression, rotation, time stamp, sequencing, window and level, colorizing, adjusting brightness and contrast, inverting the image, and the like. In some embodiments, the DICOM image is manipulated to decrease or eliminate artifact from the original image, or otherwise improve or highlight portions of the image to improve interpretation by a computer or a person.

In accordance with some embodiments, diagnostic information converter 220 may also be configured to evaluate diagnostic medical data header information (“metadata”), which could include, for example, the date of the study or a patient's date of birth, patient's name, address, phone number, email, or other demographic information, study or site information, and the like. Diagnostic information converter 220 may capture the metadata and name the rendered information provided by the medical diagnostic modality with a name appropriate to be associated with a particular EMR, such as, a unique number, data string, or code. This allows diagnostic medical information from a medical diagnostic modality to be automatically associated with the EMR of the patient from whom the diagnostic information was collected.

In accordance with various embodiments, event log 240 may be any software or hardware-software module, configured to monitor and record transactions conducted by diagnostic medical information broker system 200. Event log 240 may in electronic communication with user interface 130. In accordance with some embodiments, event log 240 is a user accessible system configured to track medical diagnostic information received by communication engine 210, converted by diagnostic information converter 220, and transmitted by communication engine 210 to a patient EMR. In another embodiment, event log 240 is configured to monitor transmissions and/or conversions, and record an event in response to a transmission or conversion failure. This allows a user to evaluate which medical diagnostic information was not properly conveyed from the medical diagnostic modality to the patient EMR.

In accordance with some embodiments, diagnostic medical information broker system 200 further comprises work list engine 230. Work list engine 230 may be any software or hardware-software system capable of creating a task list accessible by a user. Work list engine 230 may be in electronic communication with communication engine 210. Additionally, in some embodiments, work list engine 230 is configured to request and receive orders from an EMR system, such that a work list of particular diagnostics tests that need to be performed is generated. Furthermore, work list engine 230 may be configured to generate a user selectable list of diagnostic tests. This list may be transferred from work list engine 230 via communication engine 210 to a medical diagnostic modality.

In accordance with some embodiments, a user may select a particular order from the work list when the patient becomes available for the diagnostic test, perform the diagnostic test, and capture the information at the diagnostic modality. Thereafter, the user may associate the diagnostic information with the work list entry and transmit the diagnostic information to communication engine 210 for conversion and association with the patient EMR.

In some embodiments, the system 200 can be generally controlled and coordinated by operating system software, such as Windows Server, Linux Server, Windows 98, Windows NT, Windows 2000, Windows XP, Windows Vista, Unix, Linux, SunOS, Solaris, MacOS, iOS, Android, WebOS, or other compatible server or desktop operating systems. In other embodiments, the loan tracking and analysis system 100 may be controlled by a proprietary operating system. Conventional operating systems control and schedule computer processes for execution, perform memory management, provide file system, networking, I/O services, and provide a user interface, such as a graphical user interface (“GUI”), among other things. In some embodiments, various aspects of the system can be controlled from one or more of a server, a laptop computer, a cell phone, a personal digital assistant, a kiosk, a mobile device, a table computer, or an audio player, for example.

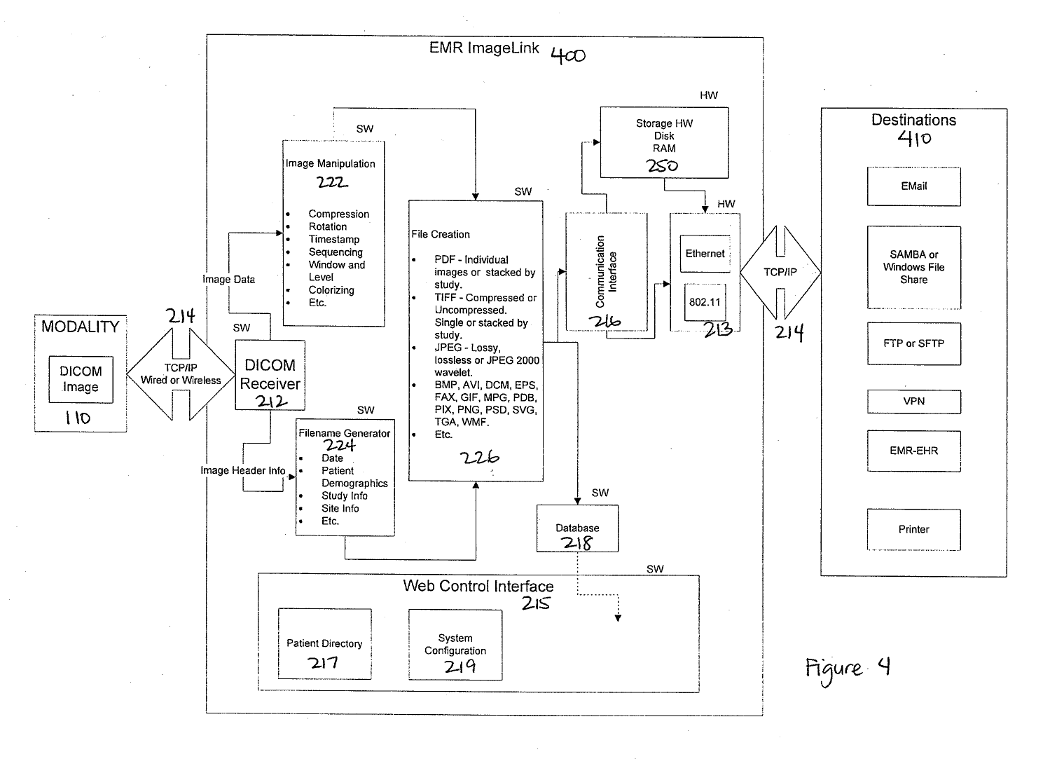

FIG. 4 illustrates a schematic flowchart of a medical information broker system 400, according to one embodiment of the invention. FIG. 4 illustrates various SW (software) and HW (hardware components), although the various components could involve, software, hardware, or a combination of the two depending on the desired result. The system 400 is operably connected via a wireless or wired connection 214, and via a transfer protocol such as TCP/IP to one, two, or more modalities 110, such as an imaging modality such as an X-ray imager for example as previously disclosed. The modalities 110 can interface directly with a communications engine 210 which may have a receiver module component 212, such as one configured to receive image data in a first format, such as a DICOM image. Upon receipt of the DICOM image by the receiver module component 212, the image can be processed by the diagnostic information converter 220. Diagnostic image converter 220 can include one, two, or more components including an image manipulation module 222, filename generator 224, and file creator 226 having functions as previously described. After processing by the diagnostic information converter 220, the image in a second converted format can be sent via a transmission module 216 within the communications engine 210 to a storage component 250, such as RAM or a hard drive, or directly through a network interface 213 via a wireless or wired protocol 214 to any of a number of destination modalities 410 as previously described. After processing, a database module 218 can be utilized to keep a record of the image and/or associated patient information. The database module 218 can utilize, for example. In some embodiments, one or more of the databases, data repositories, or data sources may be implemented using a relational database, such as Sybase, Oracle, CodeBase and Microsoft®. SQL Server as well as other types of databases such as, for example, a flat file database, an entity-relationship database, and object-oriented database, and/or a record-based database. The database(s) can interface with a control interface 215 that can be controlled by a user either locally or remotely, such as via the internet or a LAN or WAN network. The control interface 215 can include, for example, a patient directory module 217 as well as a system configuration module 219.

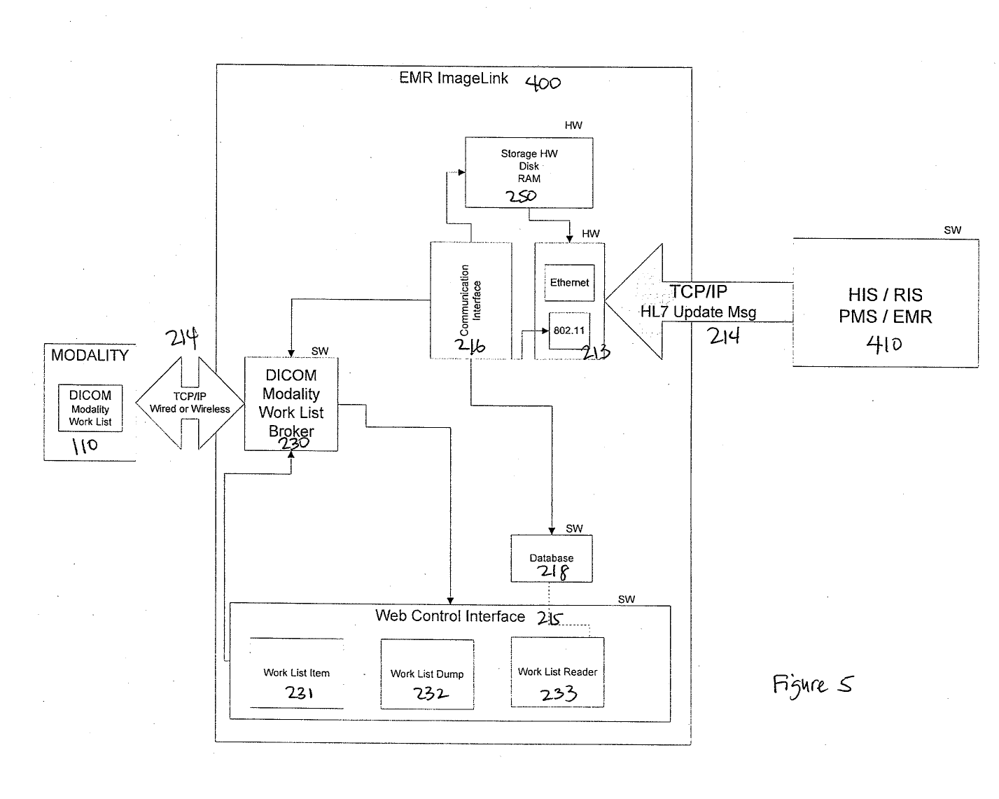

FIG. 5 is a flow diagram that illustrates various components of a diagnostic medical information broker system, some of which are as described above in FIG. 4. As shown in FIG. 5, the web control interface 215 can include a work list engine 230 as previously described, which can be in electronic communication with communication engine 210 and configured to request and receive orders from a destination modality 410, such as, for example, a Health Information System (HIS), Radiology Information System (RIS), Practice Management System (PMS), Picture Archiving and Communication System (PACS), or an EMR system, via, for example, an HL7 update messaging request such that a work list of particular diagnostic tests that need to be performed is generated. Furthermore, work list engine 230 may be configured to generate a user selectable list 231 of diagnostic tests, have a work list reader module 233, and a work list dump module 232. The list 232 may be transferred from work list engine 230 via communication engine 210 to a medical diagnostic modality.

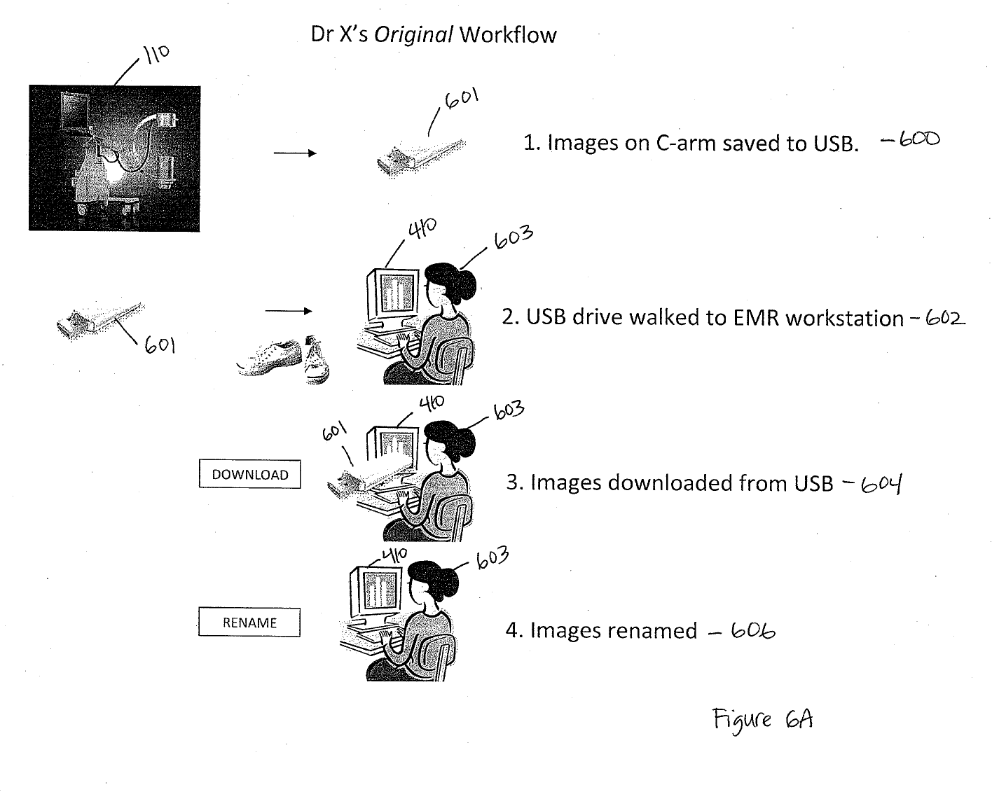

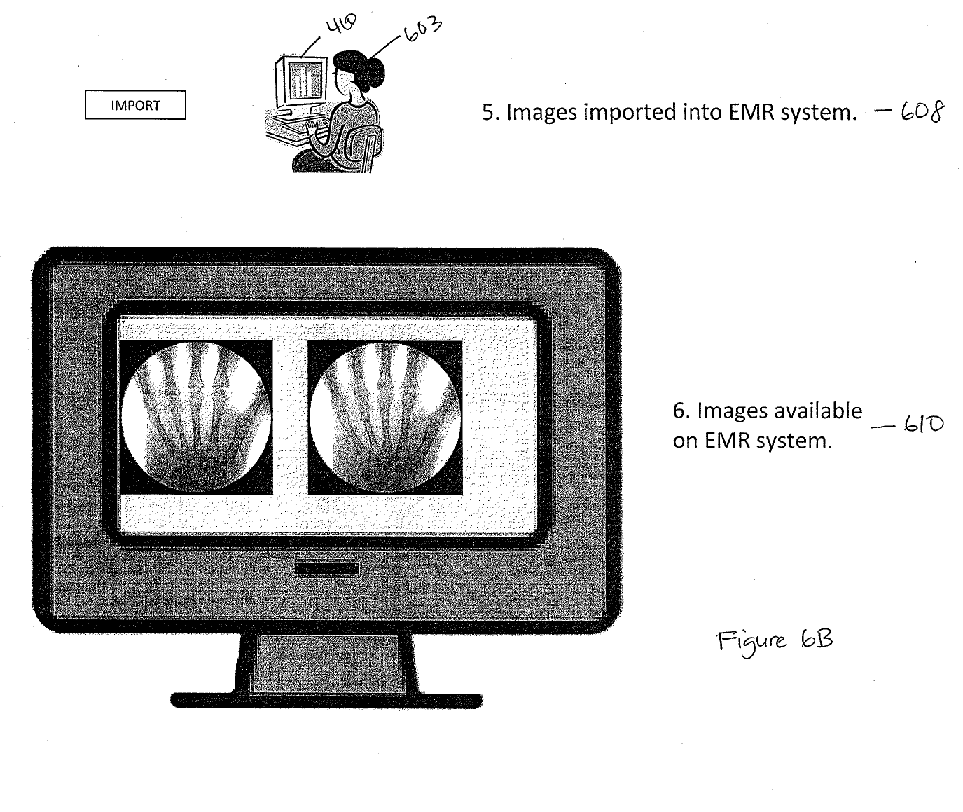

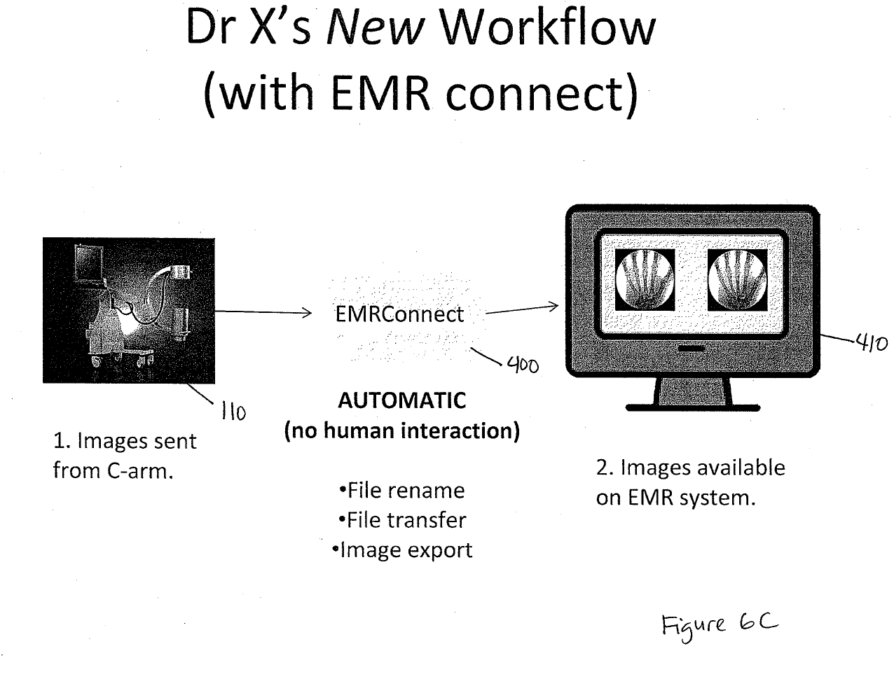

FIGS. 6A-6B illustrate conventional steps in a physician's workflow, one or more of which would have to be manually taken to move images from a diagnostic modality to an electronic medical record system. As shown in FIG. 6A, in step 600 the images from the diagnostic modality 110 are transferred to a storage device 601, such as a USB or other flash drive, hard drive, CD, DVD, or other media. As shown in step 602, the storage device 601 can then be transferred manually via an operator 604, in which images can be downloaded to a destination modality, such as an EMR workstation 410. The images can then be renamed by the operator 604 into an acceptable EMR format as shown in step 606. As shown in FIG. 6B, the images can then be imported by the operator 604 into the EMR system in step 608, and then become available on the EMR system as shown in step 610.

In contrast to FIGS. 6A-6B, FIG. 6C illustrates an automated process in which a diagnostic medical broker system can advantageously move images directly from a diagnostic modality to an electronic medical record system without necessarily requiring any intermediate steps by a human operator. As illustrated in FIG. 6C, images from the diagnostic modality 110, such as a C-arm X-ray system for example, are transferred wirelessly or via a wired communication link in a first format to a medical information broker system 400, which can receive the images, convert the images into a second format, and transmit the images to a destination modality 410 such as an EMR system.

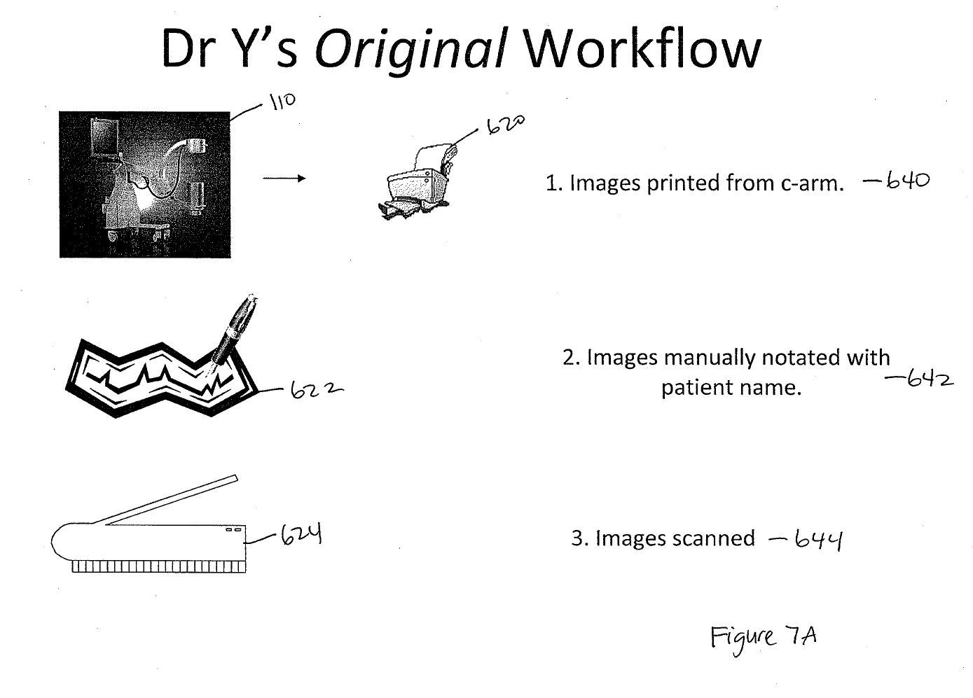

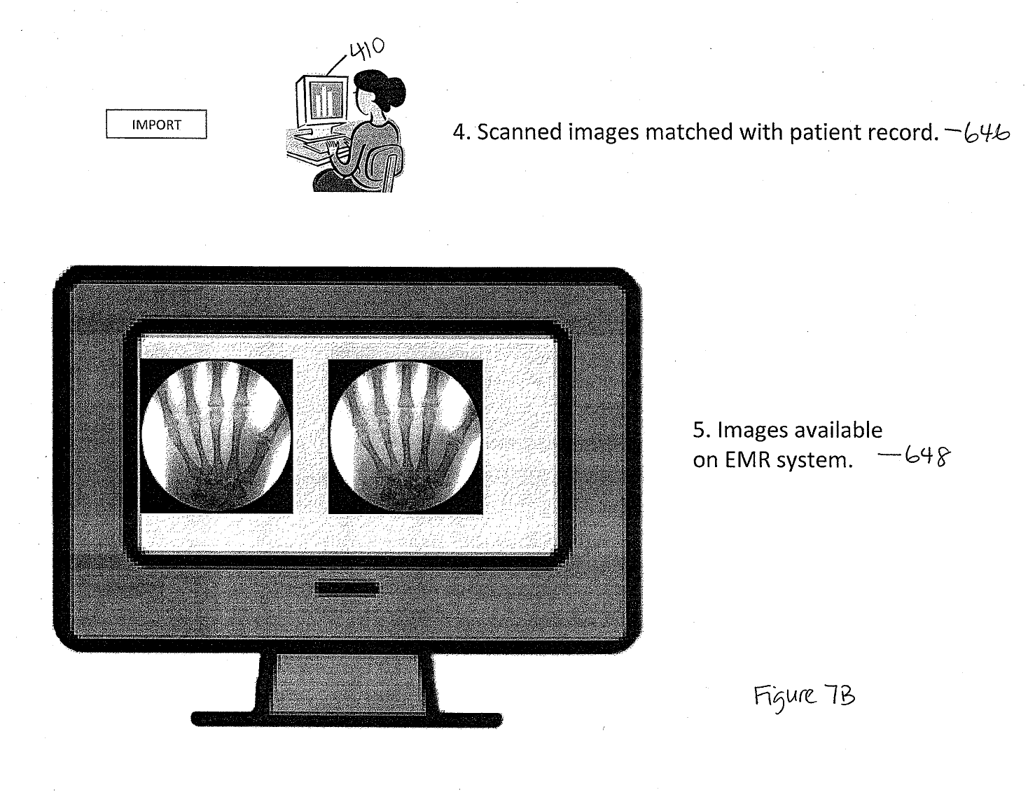

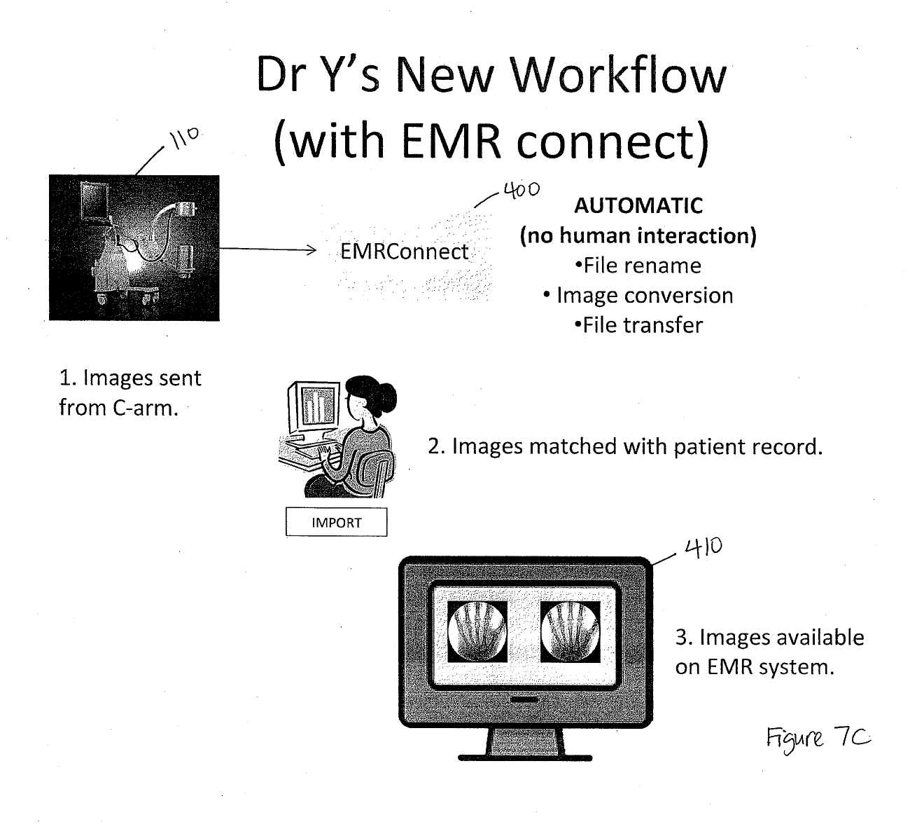

FIGS. 7A-7B illustrate conventional steps in another physician's workflow, one or more of which would have to be manually taken to move images from a diagnostic modality to an electronic medical record system. As shown in FIG. 7A, in step 640 the images from the diagnostic modality 110 are transferred to an output device 620, such as a printer. As shown in step 642, the printed images 622 can be annotated with patient's name, date of birth, location, study date, and/or other demographic information via an operator 604. As shown in step 644, the annotated printed image 624 can then be scanned via a scanner 624. As shown in FIG. 7B, the scanned images can then imported into a destination modality 410 such as an EMR system as illustrated in step 646, and manually matched with the EMR patient record; and then finally become accessible via an EMR system as illustrated in step 628.

In contrast to FIGS. 7A-7B, FIG. 7C illustrates a process in which a diagnostic medical broker system can advantageously move images directly from a diagnostic modality to an electronic medical record system without necessarily requiring, or minimizing intermediate steps by a human operator. As illustrated in FIG. 7C, images from the diagnostic modality 110, such as a C-arm X-ray system for example, are transferred wirelessly or via a wired communication link in a first format to a medical information broker system 400, which can receive the images, convert the images into a second format, and transmit the images to an EMR system. The images can then be automatically or manually matched with the destination modality 410 patient record such as an EMR system.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope. Although certain embodiments and examples are disclosed above, inventive subject matter extends beyond the specifically disclosed embodiments to other alternative embodiments and/or uses and to modifications and equivalents thereof. Thus, the scope of the claims appended hereto is not limited by any of the particular embodiments described. For example, in any method or process disclosed herein, the acts or operations of the method or process can be performed in any suitable sequence and are not necessarily limited to any particular disclosed sequence. Various operations can be described as multiple discrete operations in turn, in a manner that can be helpful in understanding certain embodiments; however, the order of description should not be construed to imply that these operations are order dependent. Additionally, the structures, systems, and/or devices described herein can be embodied as integrated components or as separate components. For purposes of comparing various embodiments, certain aspects and advantages of these embodiments are described. Not necessarily all such aspects or advantages are achieved by any particular embodiment. Thus, for example, various embodiments can be carried out in a manner that achieves or optimizes one advantage or group of advantages as taught herein without necessarily achieving other aspects or advantages as can also be taught or suggested herein. Thus, the invention is limited only by the claims that follow.

What is claimed is:

1. A medical information broker system, comprising:
a communications module configured to receive at least one file containing patient data from a diagnostic imaging modality in a first format, and send the at least one file to a destination modality in a second format;
a diagnostic information converter module in electronic communication with the communications module and configured to convert the at least one file from the first format to the second format; and
a work list engine in electronic communication with the communications module and configured to create a task list accessible via a user.

2. The medical information broker system of claim 1, wherein the first format is a DICOM format.

3. The medical information broker system of claim 1, wherein the second format is an EMR format different from the first format.

4. The medical information broker system of claim 1, wherein the second format is selected from the group consisting of: PDF, TIF, JPG, BMP, DCM, EPS, FAX, GIF, PIX, PNG, RAW, and PSD.

5. The medical information broker system of claim 1, wherein the diagnostic imaging modality comprises an X-ray imaging modality.

6. The medical information broker system of claim 5, wherein the diagnostic imaging modality comprises a C-arm imager.

7. The medical information broker system of claim 6, wherein the diagnostic imaging modality comprises a mini C-arm imager.

8. The medical information broker system of claim 1, wherein the diagnostic imaging modality comprises a computed tomography imaging modality.

9. The medical information broker system of claim 1, wherein the diagnostic imaging modality comprises a magnetic resonance imaging modality.

10. The medical information broker system of claim 1, wherein the diagnostic imaging modality comprises an ultrasonic imaging modality.

11. The medical information broker system of claim 1, wherein the destination modality comprises an electronic medical record (EMR) system.

12. The medical information broker system of claim 1, wherein the at least one file comprises medical image data.

13. The medical information broker system of claim 1, wherein the at least one file comprises medical video data.

14. The medical information broker system of claim 1, wherein the diagnostic information converter module is configured to at least one encrypt or decrypt the file.

15. The medical information broker system of claim 1, wherein the communications module is configured to transmit and receive using HL7 messaging.

16. The medical information broker system of claim 1, further comprising the diagnostic medical imaging modality.

17. The medical information broker system of claim 16, wherein the diagnostic medical imaging modality comprises a mini C-arm.

18. A computer-implemented method of brokering medical information directly between a diagnostic imaging modality and an EMR system, comprising the steps of:
receiving at least one image file from the diagnostic imaging modality in a first format;
converting the at least one image file from a first format to a second format; and
transmitting the at least one image file in the second format to the EMR system.

19. The method of claim 18, wherein the image file comprises encrypted diagnostic patient information.

20. The method of claim 19, further comprising the step of decrypting the diagnostic patient information received from the diagnostic imaging modality.

21. The method of claim 18, wherein the first format is a DICOM file format, and the second format is a EMR file format.

22. The method of claim 18, further comprising the step of naming the converted image file in the second format in a convention to associate the converted image file with a patient's electronic medical record.

23. The method of claim 18, further comprising the step of encrypting the converted image file prior to sending the image file to the EMR system.

24. The method of claim 18, wherein the diagnostic imaging modality comprises a mini C-arm.
